(19) United States
(12) Patent Application Publication
(10) Pub. No.: US 2007/0206882 A1
(43) Pub. Date: Sep. 6, 2007

(54) METHOD AND APPARATUS FOR REDUCING SIZE OF IMAGE

(75) Inventor: Chia-Hsin Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei (TW)

(21) Appl. No.: 11/424,547

(22) Filed: Jun. 16, 2006

(30) Foreign Application Priority Data
Mar. 2, 2006 (TW) 95106969

(51) Int. Cl. G06K 9/32

(52) U.S. Cl. 382/298

(57) ABSTRACT

A method for reducing the size of an image suitable for an image data having a plurality of pixels is provided. The method of the present invention comprises the following steps. First, an image data is divided into a plurality of sampling areas, and each sampling area has a predetermined number of pixels. When the image data is an odd field, a right weighting for each pixel in every sampling area is configured according to a first predetermined ratio, such that each sampling area is able to generate a first sampling pixel. When the image data is an even field, a right weighting for each pixel in every sampling area is configured according to a second predetermined ratio, such that each sampling area is able to generate a second sampling pixel. Then, a new image data is generated according to the first and second sampling pixels.

### CROSS-REFERENCE TO RELATED APPLICATION

This application claims the priority benefit of Taiwan application serial no. 95106969, filed on Mar. 2, 2006. All disclosure of the Taiwan application is incorporated herein by reference.

### BACKGROUND OF THE INVENTION

1. Field of the Invention

The present invention relates to a technique for reducing the size of an image, and more particularly, to a technique for reducing the size of an image by converting a large size image into a small size image.

2. Description of the Related Art

Since the Liquid Crystal Display (LCD) is advantageous in its characteristics of being lighter, thinner, smaller, driven by lower voltage, lower power consumption, and has wide application fields, it is widely applied in the consumer electronic or computer products such as the small and medium size portable TV, mobile phone, video camera, laptop computer, desktop display, and projection TV, and had gradually replaced the conventional CRT (Cathode-ray tube) as the main stream of the display unit.

When a larger size of image desires to be displayed on a smaller size screen (e.g. a screen on the mobile phone), the image has to be reduced first. FIG. 1 is a schematic diagram illustrating a conventional method for reducing the size of an image. Referring to FIG. 1, the white dot (i.e. the white circle) (e.g. 101) represents a pixel of an original image. A sampling operation should be performed on a predetermined number of pixels before the image can be reduced. For example, as shown in FIG. 1, every four pixels form a sampling area such as the area surrounded by the dot line 120, and each pixel in every sampling area has its individual weighting. Therefore, in the conventional method for reducing the size of the image, a sampling pixel is generated in every sampling area according to the weighting of each pixel. In FIG. 1, the sampling pixel is represented by the black dot (i.e. the full circle) such as the pixel 122. Since the quantity of the sampling pixels is less than that of the original pixels, it indicates that the resolution of the display screen is reduced, thus it can be displayed on a smaller size screen.

FIG. 2 schematically shows a hardware configuration diagram of an apparatus for reducing the size of an image complying with the design of FIG. 1. Referring to FIG. 2, the conventional image reduction apparatus 200 comprises four buffers 201, 203, 205 and 207 that are used to temporally store four sampled pixel data, respectively. In addition, the outputs of these four buffers are respectively provided to the multipliers 209, 211, 213 and 215, and the four sampling pixels are multiplied by the operation factors FA1, FA2, FA3 and FA4, respectively. Then, the multipliers 209 and 211 provide the computation results to the adder 217, and the multipliers 213 and 215 provide the computation results to the adder 219. Moreover, the outputs of the adders 217 and 219 are provided to the adder 221, and the computation results of the adders 217 and 219 are summated by the adder 221 to generate a sampling pixel. Finally, the sampling pixel is output through the buffer 223.

However, since the image reduction technique mentioned above only samples four original pixels to generate a sampling pixel, the color of the display image may not be even, which distorts the image. In addition, since the quantity of the sampled pixels is low, some pixels such as the striped circle 132 of FIG. 1 are not sampled. Therefore, an object that originally exists in the original image may disappear on the smaller size screen.

FIG. 3 is a schematic diagram illustrating an improved method for reducing the size of an image of FIG. 1. Referring to FIG. 3, in order to resolve the problem mentioned above, an idea of sampling more original pixels to generate the sampling pixel had been proposed. For example, as shown in FIG. 3, each sampling pixel (i.e. the black dot) is generated by sampling 16 original pixels. Accordingly, the image is even, such that the distortion is reduced and every pixel can be sampled.

However, since in FIG. 3 each sampling pixel is generated by referring to the weightings of the 16 original pixels, the whole image screen is blurry. In addition, since the sampling pixel is generated by computing the weightings of the 16 pixels, the hardware cost is increased.

### SUMMARY OF THE INVENTION

Therefore, it is an object of the present invention to provide a technique for reducing the size of an image, in which the size of the image is reduced with a lower hardware cost and a better quantity image is obtained.

The present invention provides a method for reducing the size of an image. The method is suitable for an image data that is interleaved composed of an odd field and an even field, and the odd and even fields are both formed by a plurality of pixels. The method of the present invention comprises the following steps: (a) determining a first sampling area of the odd field; (b) defining a weighting of the sampling pixel in the first sampling area; (c) generating a first pixel according to step (b); (d) determining a second sampling area of the even field; (e) defining a weighting of the sampling pixel in the second sampling area; (f) generating a second pixel according to step (e), wherein the corresponding locations of the second pixel and the first pixel are not the same in their respective fields; and (g) generating a third pixel according to the first and second pixels to form the reduced-size image.

In an embodiment of the present invention, the corresponding locations of the first sampling area and the second sampling area are identical or adjacent in their respective fields.

In addition, step (b) further comprises defining the weightings of the pixels located on a horizontal line and a vertical line that are perpendicular with each other in the first sampling area.

From another aspect of the present invention, the present invention provides an apparatus for reducing the size of an image comprising a horizontal weighting generator and a vertical weighting generator. Wherein, the horizontal weighting generator generates a plurality of horizontal weighting data according to a plurality record of computation factor data. Similarly, the vertical weighting generator generates a plurality of vertical weighting data according to the plurality record of computation factor data. In addition, a horizontal computing module and a vertical computing module are further comprised in the present invention. Wherein, the horizontal computing module receives a plurality of pixel data, and performs a computation on the pixel data according to the horizontal weighting data, wherein the pixel data may form a display image. The vertical computing module receives the output of the horizontal computing module, and performs a computation on the output of the horizontal computing module according to the vertical weighting data to generate a plurality of sampling pixels and the new display image.

Preferably, the present invention further comprises a computation factor output module for providing the computation factors.

In an embodiment of the present invention, the computation factor output module comprises a first switch controller and a first multiplexer. Wherein, the first switch controller generates a first selection signal, and the first multiplexer receives a first horizontal computation factor and a second horizontal computation factor and selectively provides either the first horizontal computation factor or the second horizontal computation factor to the horizontal weighting generator according to the first selection signal. In addition, the computation factor output module further comprises a second switch controller and a second multiplexer, and the operating principle of the second switch controller and the second multiplexer are the same as that of the first switch controller and the first multiplexer.

Since the sampling pixels are generated by the odd field and the even field in the present invention, the image displayed by the present invention is more even. In addition, since four pixels are sampled from a field at one time in the present invention, the display image is not blurry. Moreover, since only four pixels are sampled for computation in the present invention, the hardware cost is reduced.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic diagram illustrating a conventional method for reducing the size of an image.

FIG. 2 schematically shows a hardware configuration diagram of an apparatus for reducing the size of an image complying with the design of FIG. 1.

FIG. 3 is a schematic diagram illustrating an improved method for reducing the size of an image of FIG. 1.

FIG. 4 is a schematic diagram illustrating a method for reducing the size of an image according to a preferred embodiment of the present invention.

FIG. 5 schematically shows a flow chart illustrating a method for reducing the size of an image according to a first embodiment of the present invention.

FIG. 6 is a schematic diagram illustrating a method for reducing the size of an image according to another embodiment of the present invention.

FIG. 7 schematically shows a flow chart illustrating a method for reducing the size of an image according to a second embodiment of the present invention.

FIG. 8 is a schematic diagram illustrating a mixture of the sampling pixels generated by the odd field and the even field of FIG. 6.

FIG. 9 schematically shows a flow chart illustrating a method for reducing the size of an image according to a preferred embodiment of the present invention.

FIG. 10 schematically shows a hardware configuration diagram of an apparatus for reducing the size of an image according to a preferred embodiment of the present invention.

FIG. 11 schematically shows a hardware configuration diagram of a horizontal computing module according to a preferred embodiment of the present invention.

FIG. 12 schematically shows a hardware configuration diagram of a vertical computing module according to a preferred embodiment of the present invention.

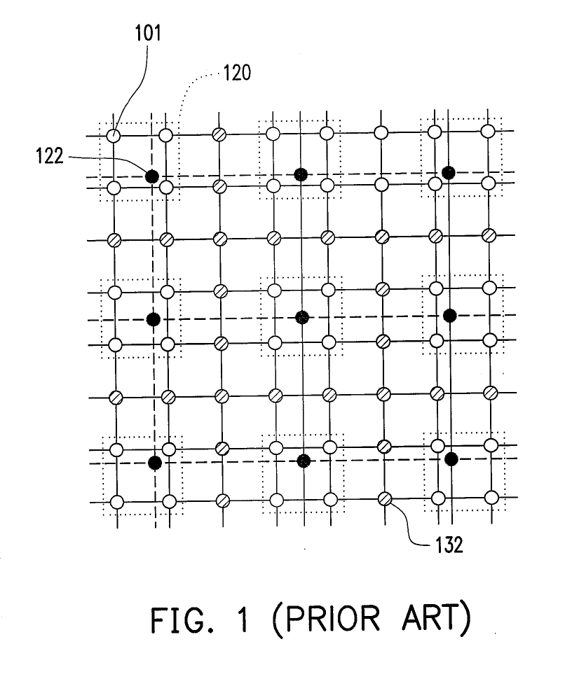

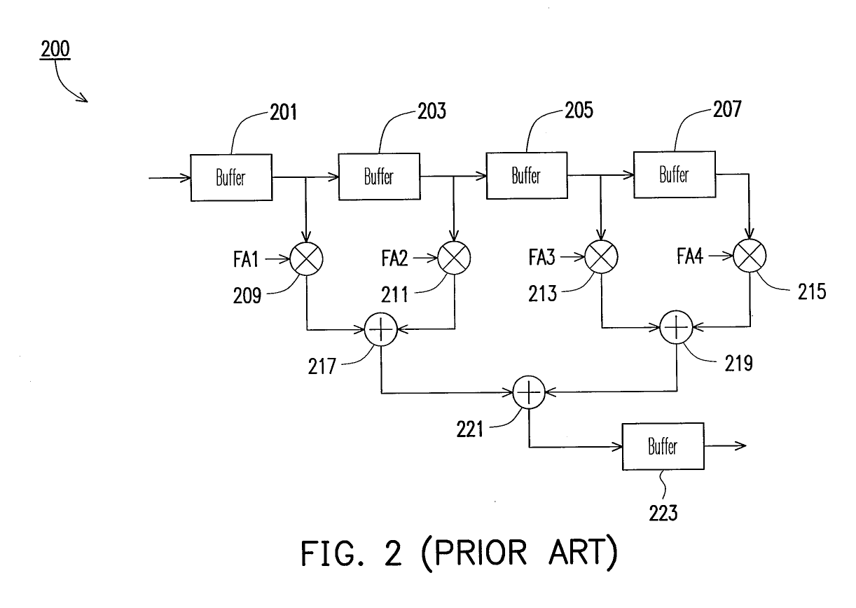

### DESCRIPTION PREFERRED EMBODIMENTS

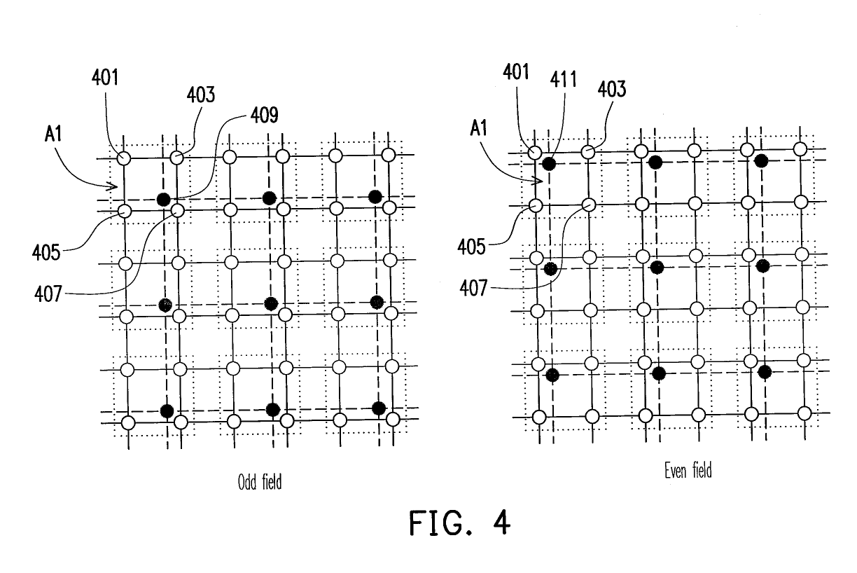

FIG. 4 is a schematic diagram illustrating a method for reducing the size of an image according to a preferred embodiment of the present invention. Referring to FIG. 4, the image data is composed of a plurality of pixels such as the pixel 401 that is arranged in an array. The main principle of the present invention is that the weighting of the sampling pixel in the image data of the odd field is different from that in the image data of the even field, and its detail is described hereinafter.

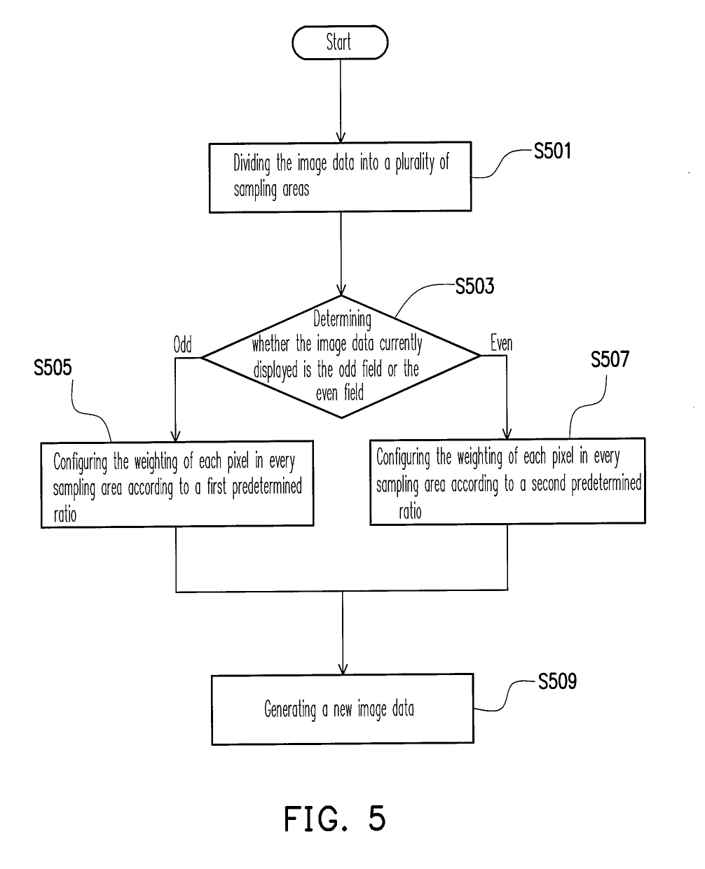

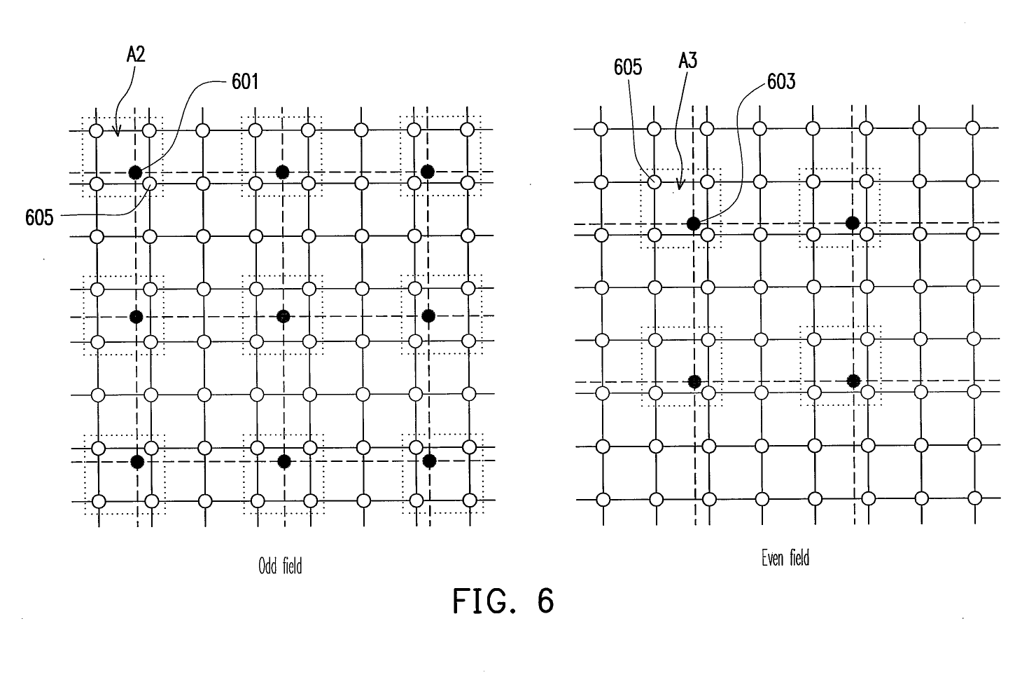

FIG. 5 schematically shows a flow chart illustrating a method for reducing the size of an image according to a first embodiment of the present invention. Referring to FIGS. 4 and 5, when an image data is received in the present invention, first in step S501, the image data of the odd and even fields is divided into a plurality of sampling areas such as the sampling area A1 of FIG. 4, and each sampling area has a predetermined number of sampling pixels. In a preferred embodiment of the present invention, the predetermined number is 4, in other words, each sampling area has 4 sampling pixels. For example, the sampling area A1 has four sampling pixels 401, 403, 405 and 407. In addition, in the embodiments of the present invention, the sampling area may be a square, and four sampling pixels are located on four corners of the square.

Then, in step S503, it is determined whether the image data currently displayed is the odd field or the even field. If it is determined that the image data currently displayed is the odd field, as described in step S505, a weighting of each sampling pixel in every sampling area is configured according to a first predetermined ratio, such that a new pixel is generated in each sampling area. Otherwise, if it is determined that the image data currently displayed is the even field, as described in step S507, a weighting of each sampling pixel in every sampling area is configured according to a second predetermined ratio that is different from the first predetermined ratio, such that a new pixel is generated in each sampling area. After the new pixels are respectively generated in the odd and even fields, step S509 is performed, in which a new image data is formed by the new pixel generated by the odd field and the new pixel generated by the even field.

Using the sampling area A1 of the odd field in FIG. 4 as an example, the sampling area A1 contains the sampling pixels 401, 403, 405 and 407. When the image data is the odd field, the first predetermined ratio is obtained by using an interpolation method to configure the weighting of each sampling pixel. It is assumed that the weighting of the sampling pixel 407 is higher than the weights of the other sampling pixels, in such case, a new pixel 409 is generated according to the weighting of each sampling pixel. Similarly, when the image data is the even field, the second predetermined ratio is obtained by using the interpolation method to configure the weighting of each sampling pixel. It is assumed in the even field that the sampling area A1 of the even field contains the sampling pixels 402, 404, 406 and 408, and the weighting of the sampling pixel 402 is higher than that the weights of the other sampling pixels, in such case, a new pixel 411 is generated according to the weighting of each sampling pixel.

As shown in FIG. 4, the locations of the new pixel 409 and the new pixel 411 in the odd and even field sampling area A1 are not the same. Accordingly, the image displayed in the odd field is compensated by the image displayed in the even field, such that the whole image looks more even.

Although four pixels are used to generate the sampling pixel in each sampling area in the present invention, preferably the present invention can generate the sampling pixel by only using three pixels in total located on the horizontal and vertical lines that are perpendicular with each other in each sampling area. Using the sampling area A1 of the odd or even field in FIG. 4 as an example, when the display data is the odd or even field, the present invention can generate the desired sampling pixel 409 by only using three pixels in total including two pixels 405 and 407 on the horizontal line and two pixels 403 and 407 on the vertical line that is perpendicular to the horizontal line.

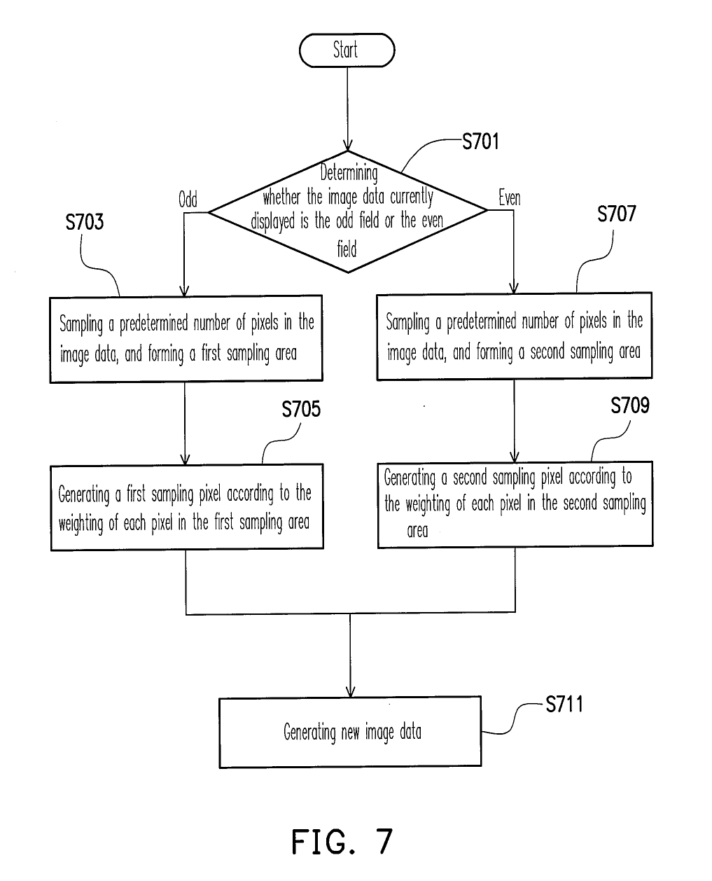

FIG. 6 is a schematic diagram illustrating a method for reducing the size of an image according to another embodiment of the present invention. FIG. 7 schematically shows a flow chart illustrating a method for reducing the size of an image according to a second embodiment of the present invention. Referring to FIGS. 6 and 7, when an image data is received in the present embodiment, whether the image data currently displayed is the odd field or the even field is determined in step S701. Assuming that the image data currently displayed is the odd field, in such case step S703 is performed, in which a predetermined number of pixels in the image data is sampled and a sampling area such as the sampling area A2 of FIG. 6 is formed. Then, in step S705, a sampling pixel 601 is generated according to the weighting of each pixel in the sampling area A2.

Oppositely, when the image data currently displayed is the even field, the same number of pixels in the image data are sampled and a sampling area such as the sampling area A3 of FIG. 6 is formed in step S707. In the present embodiment, the sampling area A2 is adjacent to the sampling area A3. For example, as shown in FIG. 6, the pixel 605 is disposed on the bottom right corner of the sampling area A2, and the pixel 606 is disposed on the top left corner of the sampling area A3. After step S707 is completed, the sampling pixel such as the sampling pixel 603 of FIG. 6 is generated according to the weighting of each pixel in the sampling area A3 in step S709. After the sampling pixel of the odd field and the sampling pixel of the even field are obtained, the present invention performs step S711, in which a new image data is formed by using the sampling pixel of the odd field and the sampling pixel of the even field.

It is known from the descriptions mentioned above that the odd and even fields are used as two sampling areas that are compensated with each other, and the corresponding locations of the odd field and the even field may be identical (as shown in FIG. 4) or not the same (as shown in FIG. 6) in their respective fields.

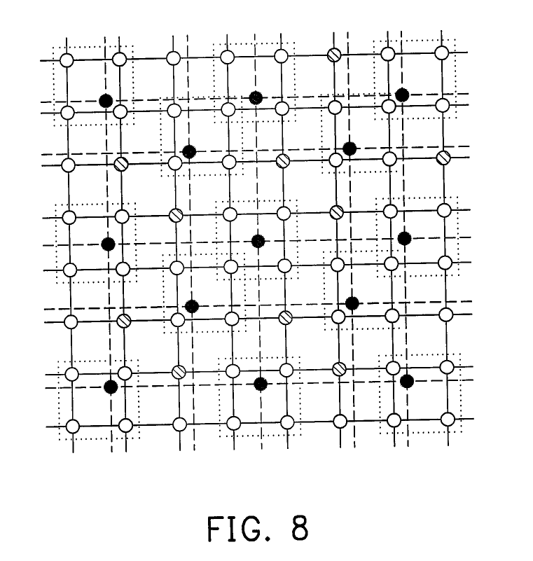

FIG. 8 is a schematic diagram illustrating a mixture of the sampling pixels generated by the odd field and the even field of FIG. 6. It is obvious from FIG. 8 that the method for reducing the size of the image disclosed in FIG. 7 can effectively reduce the number of the non-sampled pixels (represented by the striped circles). In other words, it is not possible to find all pixels in a whole row or a whole column that are not sampled in the image data.

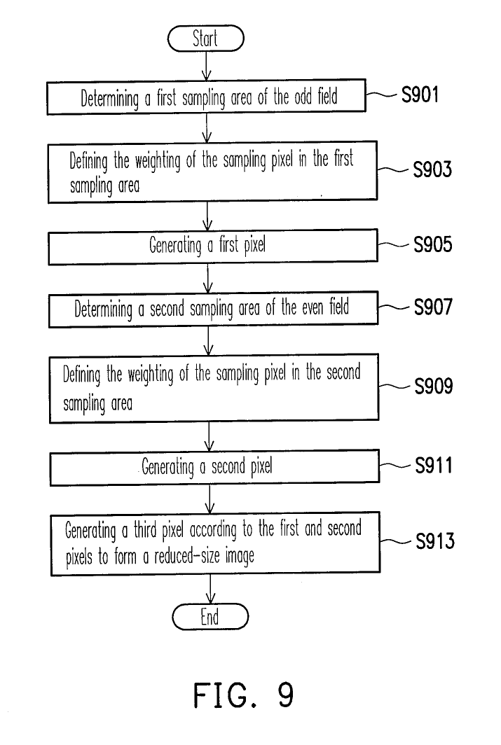

In summary of two embodiments mentioned above, the present invention provides a method for reducing the size of an image as shown in FIG. 9. Referring to FIG. 9, first in step S901, the present invention determines a first sampling area of the odd field in an image data. Then, a weighting of the sampling pixel in the first sampling area is defined in step S903 to generate a first pixel as described in step S905. In addition, in step S907, a second sampling area of the even field is determined. Then, a weighting of the sampling pixel in the second sampling area is defined in step S909 to generate a second pixel as described in step S911. Wherein, the corresponding locations of the first pixel and the second pixel in its respective filed are not the same as shown in the first and second embodiments mentioned above. Then, in step S913, a third pixel is generated according to the first pixel and the second pixel in order to form a reduced-size image.

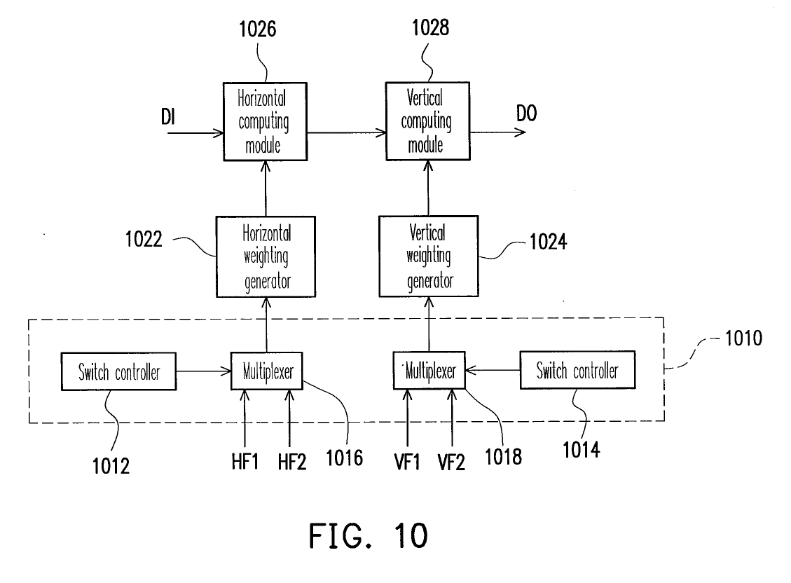

FIG. 10 schematically shows a hardware configuration diagram of an apparatus for reducing the size of an image according to a preferred embodiment of the present invention. Referring to FIG. 10, the apparatus for reducing the size of the image provided by the present invention comprises a computation factor output module 1010 for providing the outputs to the horizontal weighting generator 1022 and the vertical weighting generator 1024. In addition, the output of the horizontal weighting generator 1022 is provided to the horizontal computing module 1026, and the output of the vertical weighting generator 1024 is provided to the vertical computing module 1028. Moreover, the horizontal computing module 1026 receives a plurality record of pixel data through the input terminal DI of the apparatus for reducing the size of the image provided by the present invention. Furthermore, the output of the horizontal computing module 1026 is provided to the vertical computing module 1028, and the output of the vertical computing module 1028 is provided to the output terminal DO of the apparatus for reducing the size of the image provided by the present invention.

The computation factor output module 1010 comprises the switch controllers 1012 and 1014 and the multiplexers 1016 and 1018. Wherein, the multiplexer 1016 receives the horizontal computation factors HF1 and HF2, and the multiplexer 1018 receives the vertical computation factors VF1 and VF2. In addition, the switch controller 1012 controls the multiplexer 1016 to provide either the horizontal computation factor HF1 or HF2 to the horizontal weighting generator 1022. Similarly, the switch controller 1014 controls the multiplexer 1018 to provide either the vertical computation factor VF1 or VF2 to the vertical weighting generator 1024. After the horizontal weighting generator 1022 and the vertical weighting generator 1024 had received the computation factors provided by the computation factor output module 1010, the outputs are generated and provided to the horizontal computing module 1026 and the vertical computing module 1028.

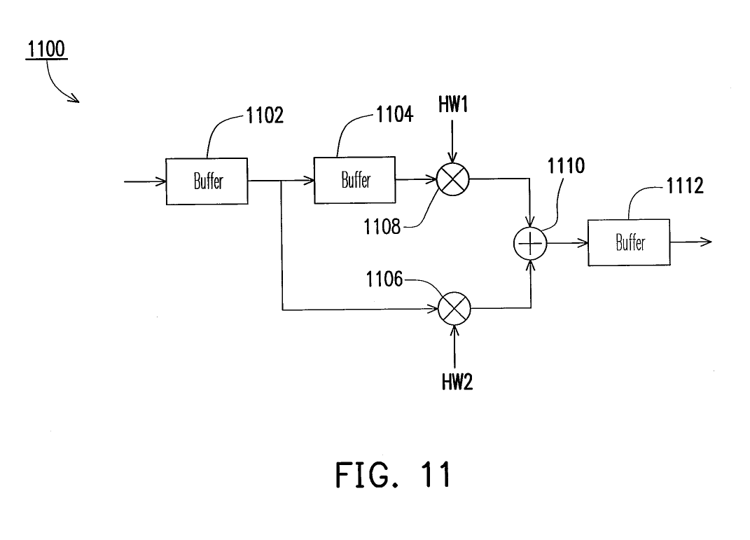

FIG. 11 schematically shows a hardware configuration diagram of a horizontal computing module according to a preferred embodiment of the present invention suitable for the horizontal computing module 1026 of FIG. 10. Referring to FIG. 11, the horizontal computing module 1100 comprises a buffer 1102 for receiving a plurality record of pixel data, wherein the pixel data form a display image such as the pixel 401 of FIG. 4.

After the first record of pixel data is provided to the buffer 1102, the received pixel data is then provided to the buffer 1104 and temporally stored therein. After the next record of pixel data is provided to the buffer 1102, the buffers 1102 and 1104 provide the outputs to the multipliers 1106 and 1108, respectively. The multipliers 1108 and 1106 respectively multiplies the outputs of the buffers 1106 and 1102 by the horizontal weightings HW1 and HW2, and provides the computation results to the adder 1110. Finally, the output of the adder 1110 is output through the buffer 1112.

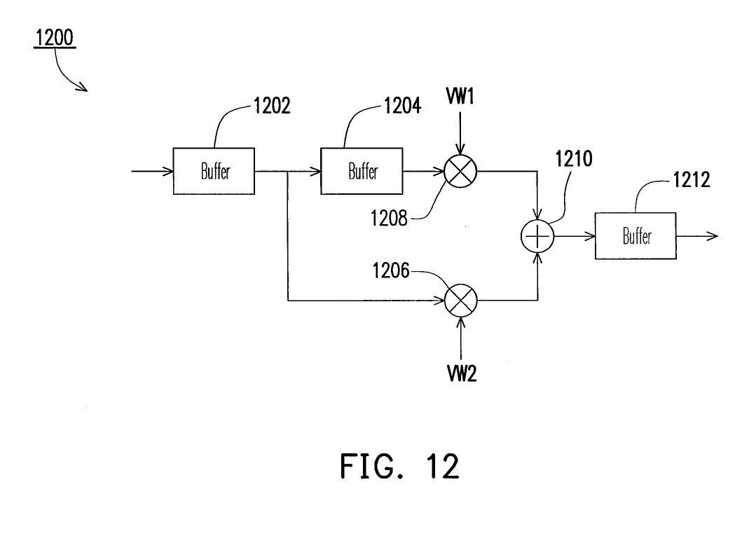

FIG. 12 schematically shows a hardware configuration diagram of a vertical computing module according to a preferred embodiment of the present invention. Referring to FIG. 12, similar to the horizontal computing module 1100, the vertical computing module 1200 also comprises two buffers 1202 and 1204. Wherein, the buffer 1202 receives the output of the horizontal computing module 1100. Similarly, the outputs of the buffers 1202 and 1204 are provided to the multipliers 1206 and 1208. Wherein, the multiplier 1208 multiplies the output of the buffer 1204 by the vertical weighting VW1, and the multiplier 1206 multiplies the output of the buffer 1202 by the vertical weighting VW2. In addition, the outputs of the multipliers 1206 and 1208 are provided to the adder 1210 and output through the buffer 1212.

As described above, the apparatus provided by FIG. 10 can implement the method for reducing the size of the image described in FIG. 5 or 7. For example, the vertical computing module 1028 can multiply two pixels on the vertical line in the sampling area by the corresponding weightings, and the horizontal computing module 1026 can multiply two pixels on the horizontal line in the sampling area by the corresponding weightings, such that the corresponding sampling pixels are generated to form the reduced-size image data.

In summary, the present invention at least has following advantages:

1. In the present invention, different sampling pixels are generated by the odd field and the even field, such that the color of the reduced-size display image looks more even.

2. Since four pixels are sampled at one time in the present invention, the reduced-size display image still looks clear.

3. Since the present invention only performs the computation of the pixels located on the horizontal and the vertical lines that are perpendicular with each other in the sampling area., the hardware configuration can be simplified and hardware cost is further reduced.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A method for reducing a size of an image suitable for an image data interleaved composed of an odd field and an even field, wherein the odd field and even field are both formed by a plurality of pixels, and the method for reducing the size of the image comprises:
(a) determining a first sampling area of the odd field;
(b) defining a weighting of the sampling pixel in the first sampling area;
(c) generating a first pixel according to step (b);
(d) determining a second sampling area of the even field;
(e) defining a weighting of the sampling pixel in the second sampling area;
(f) generating a second pixel according to step (e), wherein the corresponding locations of the second pixel and the first pixel are not the same in their respective fields; and
(g) generating a third pixel according to the first and second pixels to form a reduced-size image.

2. The method for reducing the size of the image of claim 1, wherein the corresponding locations of the first sampling area and the second sampling area are identical in their respective fields.

3. The method for reducing the size of the image of claim 1, wherein the corresponding locations of the first sampling area and the second sampling area are adjacent in their respective fields.

4. The method for reducing the size of the image of claim 1, wherein the first sampling area and the second sampling area both comprise 4 sampling pixels respectively.

5. The method for reducing the size of the image of claim 1, wherein the first sampling area and the second sampling area are a square, and the sampling pixels inside the square are located on the four vertexes of the square.

6. The method for reducing the size of the image of claim 1, wherein step (b) further comprises:
defining the weightings of the pixels located on a horizontal line and a vertical line that are perpendicular with each other in the first sampling area.

7. An apparatus for reducing a size of an image, comprising:
a horizontal weighting generator for generating a plurality of horizontal weighting data according to a plurality of computation factor data;
a vertical weighting generator for generating a plurality of vertical weighting data according to the plurality of computation factor data;
a horizontal computing module for receiving the plurality of pixel data and performing a computation on the pixel data according to the horizontal weighting data, wherein the pixel data form a display image; and
a vertical computing module for receiving an output of the horizontal computing module and performing a computation on the output of the horizontal computing module according to the vertical weighting data to generate a plurality of sampling pixels and a new display image.

8. The apparatus for reducing the size of the image of claim 7, further comprising:
a computation factor output module for providing the computation factors.

9. The apparatus for reducing the size of the image of claim 8, wherein the computation factor output module further comprises:
a first switch controller for generating a first selection signal;
a first multiplexer for receiving a first horizontal computation factor and a second horizontal computation factor and selectively providing either the first horizontal computation factor or the second horizontal computation factor to the horizontal weighting generator according to the first selection signal;
a second switch controller for generating a second selection signal; and
a second multiplexer for receiving a first vertical computation factor and a second vertical computation factor and selectively providing either the first vertical computation factor or the second vertical computation factor to the vertical weighting generator according to the second selection signal.

10. The apparatus for reducing the size of the image of claim 7, wherein the horizontal computing module comprises:
a first buffer for receiving the pixel data;
a second buffer for receiving an output of the first buffer;
a first multiplier for multiplying an output of the second buffer by a first horizontal weighting generated by the horizontal weighting generator;
a second multiplier for multiplying the output of the first buffer by a second horizontal weighting generated by the horizontal weighting generator;
a first adder for adding a computation result of the first multiplier to a computation result of the second multiplier; and
a third buffer for receiving a computation result of the first adder and providing the received computation result to the vertical computing module.

11. The apparatus for reducing the size of the image of claim 7, wherein the vertical computing module comprises:
a fourth buffer for receiving an output of the horizontal computing module;
a fifth buffer for receiving an output of the fourth buffer;
a third multiplier for multiplying an output of the fifth buffer by a first vertical weighting generated by the vertical weighting generator;
a fourth multiplier for multiplying the output of the fourth buffer by a second vertical weighting generated by the vertical weighting generator;
a second adder for adding a computation result of the third multiplier to a computation result of the fourth multiplier; and
a sixth buffer for providing a computation result of the second adder to generate the sampling pixels.
